(19) United States
(12) Patent Application Publication
(10) Pub. No.: US 2026/0022241 A1
(43) Pub. Date: Jan. 22, 2026

(54) CURABLE COMPOSITION AND COATED SUPERSTRATE

(71) Applicant: Canon Kabushiki Kaisha, Tokyo (JP)

(72) Inventors: Kui XU, Austin, TX (US); Weijun LIU, Cedar Park, TX (US); Timothy Brian STACHOWIAK, Austin, TX (US); Fen WAN, Austin, TX (US); Sophia A. ORTEGA-REIDEL, Austin, TX (US)

(21) Appl. No.: 18/778,138

(22) Filed: Jul. 19, 2024

(51) Int. Cl. C08L 33/12; C09D 133/12

(52) U.S. Cl. CPC C08L 33/12; C09D 133/12

(57) ABSTRACT

A curable composition can comprise a first a reactive acrylate polymer being essentially free of fluorine, a reactive polysilsesquioxane, and a solvent, wherein the reactive polysilsesquioxane comprises hydroxyl groups and structure-units of formula (1)

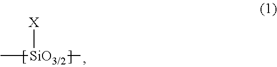

wherein X is alkyl, or aryl, or arylalkyl, or fluorine-containing alkyl, or any combination thereof. The viscosity of the curable composition can be not greater than 50 mPa·s; a ratio of acrylate polymer to the polysilsesquioxane is at least 2:1 and not greater than 20:1; and a cured layer of the curable composition may have a water contact angle of least 75 degrees. The curable composition is suitable for making a coated superstrate, wherein the coated superstrate has excellent hydrophobic and oleophobic properties.

### FIELD OF THE DISCLOSURE

The present disclosure relates to a curable composition and a superstrate coated with the curable composition for Inkjet Adaptive Planarization.

### BACKGROUND

Inkjet Adaptive Planarization (IAP) requires the use of a superstrate having a high flatness and a super-hydrophobic and super-oleophobic working surface. Such working surfaces can comprise a polymeric layer applied by spin-coating, wherein the polymeric layer contains as majority a perfluorinated polymer. Because of the high material costs and technical challenges of handling perfluorinated polymers, an intermediate layer is often included underneath the perfluorinated layer. Other disadvantages of using perfluorinated polymers as coating material are the limited solubility of these polymers in non-fluorinated solvents (non-fluorinated solvents being desired because of their low costs), as well as problems during filtering at filter pore sizes in the range of 10 nm and below.

There exists a need to improve spin-coated superstrates, wherein the hydrophobic coating layer has low material costs and allows simplified and efficient handling, such as improved solubility in low-cost solvents, easy processability, and less environmental concerns.

### SUMMARY

In one embodiment, a curable composition can comprise a first polymer, the first polymer including a reactive acrylate polymer, the reactive acrylate polymer being essentially free of fluorine; a second polymer, the second polymer including a reactive polysilsesquioxane; and a solvent, wherein the reactive polysilsesquioxane comprises hydroxyl groups and structure-units of formula (1):

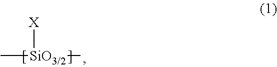

wherein X is alkyl, or aryl, or arylalkyl, or fluorine-containing alkyl, or any combination thereof; a viscosity of the curable composition is not greater than 50 mPa·s; a ratio of the first polymer to the second polymer is at least 2:1 and not greater than 20:1; and a water contact angle to a solid polymeric layer formed after curing the curable composition is at least 75 degrees.

In one aspect of the curable composition, the reactive polysilsesquioxane can be a polymerization product of at least one first Si-containing monomer having a structure of formula (2) and at least one second Si-containing monomer having a structure of formula (3):

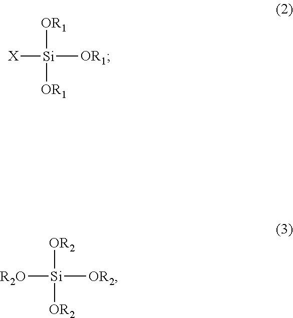

wherein R₁ and R₂ is C₁-C₆ alkyl, and X is alkyl, or aryl, or aryl-alkyl, or fluorine-containing alkyl. In a particular aspect, the second Si-containing monomer can be tetraethyl orthosilicate (TEOS).

In a further aspect, the amount of the second Si-containing monomer can be at least 20 wt % based on the total weight of monomers forming the polysilsesquioxane.

In one embodiment of the curable composition, the polysilsesquioxane can comprises fluorine. In one aspect X of formula (1) can be —(CH₂)ₘ—CₙF₂ₙ₊₁, with n being 4-18, and m being 0-4.

In another embodiment, the polysilsesquioxane of the curable composition can have the structure of formula (1) and being free of fluorine. In a certain aspect, X of formula (1) can be methyl, or ethyl, or isobutyl, or phenyl, or a combination thereof.

In a further embodiment, the acrylate polymer of the curable composition can comprise structure units of formula (4) and formula (5):

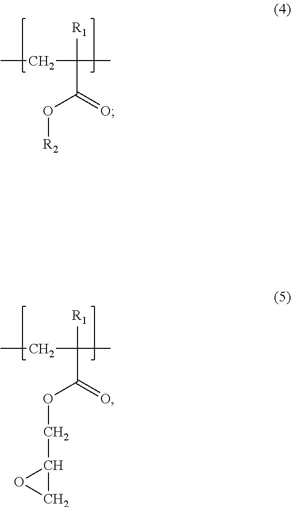

with R₁ being H or C₁-C₆ alkyl, R₂ being substituted or unsubsituted C₁-C₁₈ alkyl.

In a particular aspect, the acrylate polymer can be a copolymer of methyl methacrylate (MMA) and glycidyl methacrylate (GMA).

In another aspect of the curable composition, a molecular weight of the acrylate polymer can be at least 2,000 g/mol.

In a further aspect of the curable composition, the amount of the solvent can be at least 50 wt % based on the total weight of the curable composition. In particular aspects, the solvent can include ethyl acetoacetate (EAA), ethyl lactate (EL), cyclohexanone, propylene glycol methyl ether acetate (PGMEA), or γ-butyrolactone (GBL).

In one aspect, the curable composition can further comprise a thermal acid generator as a crosslinking catalyst.

In a certain aspect, the curable composition can be essentially free of particles.

In another aspect, the amount of the polysilsesquioxane can be at least 0.01 wt % and not greater than 20 wt % based on the total weight of the curable composition.

In one embodiment, a coated superstrate can comprise: a superstrate blank having a first surface and a second surface, the first surface and the second surface being opposite to each other; a solid polymeric layer directly overlying the first surface of the superstrate blank, wherein the solid polymeric layer is a cured coating of a curable composition, the curable composition comprising: a first polymer, the first polymer including a reactive acrylate polymer, the reactive acrylate polymer being essentially free of fluorine; a second polymer, the second polymer including a reactive polysilsesquioxane; and a solvent, wherein the reactive polysilsesquioxane comprises hydroxyl groups and structure-units of formula (1):

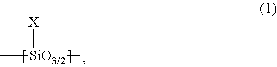

wherein X is alkyl, or aryl, or arylalkyl, or fluorine-containing alkyl; a viscosity of the curable composition is not greater than 50 mPa·s; a ratio of the first polymer to the second polymer is at least 2:1 and not greater than 20:1; and a water contact angle to the solid polymeric layer is at least 75 degrees.

In one aspect of the coated superstrate, the thickness of the solid polymeric layer can be at least 5 nm and not greater than 10 microns.

In another embodiment, a system for planarizing a formable material can comprise: the above-described coated superstrate coupled to a superstrate holder; and a formable material positioned on a substrate, wherein the coated superstrate is positioned above a top surface of the formable material and configured for planarizing the top surface of the formable material.

In yet a further embodiment, a method of forming a coated superstrate can comprise: providing a superstrate blank having a first surface and a second surface, the first surface being opposite to the second surface; applying by spin-coating on the first surface of the superstrate blank a liquid layer of the above-described curable composition; and curing the curable composition to form the solid polymeric layer.

### BRIEF DESCRIPTION OF THE DRAWINGS

Embodiments are illustrated by way of example and are not limited in the accompanying figure.

FIG. 1 includes a line drawing illustrating a section of a side-view of a coated superstrate according to one embodiment.

FIG. 2 includes a line drawing illustrating a system for planarizing a formable material including a coated superstrate according to one embodiment.

Skilled artisans appreciate that elements in the figures are illustrated for simplicity and clarity and have not necessarily been drawn to scale. For example, the dimensions of some of the elements in the figures may be exaggerated relative to other elements to help improve understanding of embodiments of the invention.

### DETAILED DESCRIPTION

The following description is provided to assist in understanding the teachings disclosed herein and will focus on specific implementations and embodiments of the teachings. This focus is provided to assist in describing the teachings and should not be interpreted as a limitation on the scope or applicability of the teachings.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the imprint and lithography arts.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The present disclosure is directed to a curable composition comprising a first polymer, the first polymer including a reactive acrylate polymer which is essentially free of fluorine; a second polymer, the second polymer including a reactive polysilsesquioxane; and a solvent, wherein the reactive polysilsesquioxane can comprise hydroxyl groups and structure-units of formula (1):

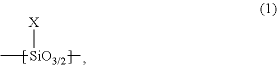

with X being alkyl, or aryl, or aryl-alkyl, or fluorine-containing alkyl. Furthermore, a viscosity of the curable composition can be not greater than 50 mPa·s; a ratio of the first polymer to the second polymer can be at least 2:1 and not greater than 20:1; and a cured layer of the curable composition can have a water contact angle of at least 75 degrees.

As used herein, the term “reactive” in combination with “acrylate polymer” and “polysilsesquioxane” means that these polymers contain functional groups which can be involved in polymerization and cross-linking reactions.

Furthermore, as used herein, the term “reactive acrylate polymer,” relates to an acrylate homopolymer or an acrylate copolymer containing functional groups. In aspects, the reactive acrylate polymer can be a substituted or unsubstituted poly (alkyl alkylacrylate) or substituted or unsubstituted poly (alkyl acrylate). In non-limiting examples the acrylate polymer can be a poly (methyl methacrylate), or a poly(methyl acrylate), or a poly (ethyl methacrylate), or a poly (ethyl acrylate) and copolymers thereof.

In a particular aspect, the reactive acrylate polymer can be essentially free of fluorine. As used herein, being essentially free of fluorine means that an amount of fluorine in the acrylate polymer is not greater than 1 wt % based on the total weight of the acrylate polymer, or not greater than 0.5 wt %, or not greater than 0.1 wt %. In a particular certain aspect, the reactive acrylate polymer can be free of fluorine.

It has been surprisingly found that the curable composition of the present disclosure is suitable for forming a solid polymeric layer on a superstrate, which can be a very cost-efficient replacement of expensive super-hydrophobic and super oleophobic fluoropolymer coatings, such as, for example, Cytop.

In one embodiment, the ratio of the first polymer (reactive acrylate polymer) to the second polymer (reactive polysilsesquioxane) can be at least at least 2:1, or at least 4:1, or at least 5:1, or at least 10:1, or at least 15:1, or at least 20:1, or at least 25:1, or at least 30:1, or at least 35:1, or at least 40:1, or at least 45:1, or at least 50:1. In another aspect, the ratio of the acrylate polymer to the polysilsesquioxane may be not greater than 80:1, or not greater than 50:1, or not greater than 30:1, or not greater than 20:1, or not greater than 16:1, or not greater than 10:1, or not greater than 8:1, or not greater than 6:1.

In one aspect, both the reactive acrylate polymer and the reactive polysilsesquioxane can comprise functional groups selected from the group of glycidyl groups, or hydroxyl groups, or carboxylic acid groups, or alkoxysilane groups, or vinyl groups, or acrylate groups, or any combinations thereof. In a particular aspect, the reactive acrylate polymer can comprise glycidyl groups and the reactive polysilsesquioxane can comprise hydroxyl groups.

In a particular aspect, the reactive acrylate polymer can be a copolymer formed from an alkyl-acrylate and a glycidyl-acrylate. For example, the acrylate polymer can comprise structure units of formula (4) and formula (5):

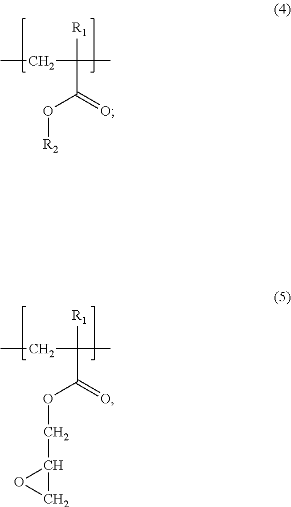

with R₁ being H or C₁-C₆ alkyl; R₂ being substituted or unsubsituted C₁-C₁₈ alkyl, or C₁-C₆ alkyl.

In a certain particular aspect, the acrylate polymer can be a copolymer formed from methyl methacrylate and glycidyl methacrylate.

The reactive polysilsesquioxane (the second polymer), also called herein “PSS,” can comprise fluorine or can be free of fluorine.

In one embodiment, the reactive polysilsesquioxane can be a polymerization product made by hydrolysis and polycondensation of at least one first Si-containing monomer having a structure of formula (2), and at least one second Si-containing monomer having a structure of formula (3):

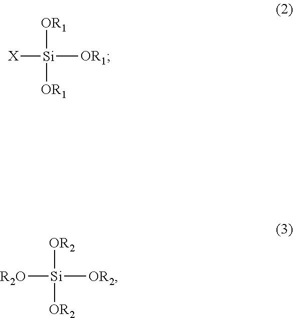

wherein R₁ and R₂ can be C₁-C₈ alkyl, and X corresponds to X of formula (1), such as being alkyl, or aryl, or arylalkyl, or fluorine-containing alkyl.

In one aspect, the first Si-containing monomer can be a C₁-C₈ alkyltrimethoxysilane, or phenyltrimethoxysilane, or a fluorine-containing C₁-C₈-alkyltrimethoxysilane. Specific non-limiting examples of the first Si-containing monomer can be methyltrimethoxysilane, or isobutyltrimethoxysilane, or phenyltrimethoxysilane, or 1H,1H,2H,2H-nonafluorohexyl-trimethoxysilane, or any combination thereof.

In another aspect, the second Si-containing monomer can be tetraethyl orthosilicate (TEOS).

In a particular aspect, the polysilsesquioxane can be formed by at least two different monomers falling under formula 2 (the first Si-containing monomer); and one monomer falling under formula 3 (the second Si-containing monomer).

In a further aspect, the amount of the second Si-containing monomer for forming the reactive polysilsesquioxane can be at least 20 mol % based on the total molar amount of monomers forming the polysilsesquioxane, or at least 25 mol %, or at least 30 mol %, or at least 35 mol %, or at least 40 mol %, or at least 45 mol %, or at least 50 mol %, or at least 55 mol %, or at least 60 mol %. In a another aspect, the amount of the second Si-containing monomer may be not greater than 70 mol %, or not greater than 60 mol %, or not greater than 55 mol %.

In a particular aspect, the second Si-containing monomer can be TEOS in an amount from 30 mol % to 55 mol %.

In one embodiment, the reactive polysilsesquioxane (PSS) of the curable composition may comprise fluorine.

In one aspect, the reactive PSS can comprise fluorine and the reactive acrylate polymer may be free of fluorine.

The amount of fluorine in the reactive polysilsesquioxane (PSS) can be at least 0.01 wt % based on the total weight of the polysilsesquioxane, or at least 0.1 wt %, or at least 1 wt %. In another aspect, the amount of fluorine may be not greater than 20 wt %, or not greater than 10 wt %, or not greater than 5 wt % based on the total weight of the reactive polysilsesquioxane.

In a particular aspect, the reactive PSS can contain structure units of formula (I), wherein X can be —(CH₂)ₘ—CₙF₂ₙ₊₁, with n being 4-18, and m being 0-4. In a particular certain aspect, n can be 4-10 and m can be 1-2.

In another embodiment, the reactive polysilsesquioxane (PSS) of the curable composition can be free of fluorine.

In one aspect, the reactive PSS can be free of fluorine and the reactive polyacrylate can be free of fluorine.

If the reactive PSS is free of fluorine, the PSS can comprise structure units of formula (1) wherein X is a fluorine-free hydrophobic residue, for example, X can be C₄-C₁₈-alkyl, or C₄-C₁₈-isoalkyl, or phenyl, or phenyl-C₄-C₁₈ alkyl, or phenyl-C₄-C₁₈-isoalkyl. The hydrophobic character of the formed PSS can be balanced by using a combination of monomers, wherein some monomers can contain for X the above-described hydrophobic rest, and other monomers can have for X a hydrophilic rest.

In one aspect, the molecular weight of the reactive acrylate polymer can be at least 1000 g/mol, or at least 2000 g/mol, or at least 3000 g/mol, or at least 5000 g/mol, or at least 10,000 g/mol, or at least 20,000 g/mol, or at least 50,000 g/mol, or at least 100,000 g/mol, or at least 200,000 g/mol, or at least 500,000 g/mol. In another aspect, the molecular weight of the acrylate polymer may be not greater than 1,000,000 g/mol, or not greater than 800,000 g/mol, or not greater than 500,000 g/mol, or not greater than 100,000 g/mol, or not greater than 50,000 g/mol.

In a further aspect, the molecular weight of the reactive polysilsesquioxane can be at least 500 g/mol, or at least 1000 g/mol, or at least 2000 g/mol, or at least 5000 g/mol, or at least 10,000 g/mol, or at least 20,000 g/mol, or at least 50,000 g/mol. In another aspect, the molecular weight of the polysilsesquioxane may be not greater than 100,000 g/mol, or not greater than 50,000 g/mol, or not greater than 10,000 g/mol, or not greater than 5,000 g/mol, or not greater than 1000 g/mol.

In a further embodiment, the amount of the acrylate polymer can be at least 0.1 wt % based on the total weight of the curable composition, or at least 0.5 wt %, or at least 1 wt %, or at least 3 wt %, or at least 5 wt %, or at least 8 wt %, or at least 10 wt %, or at least 15 wt %, or at least 20 wt %. In another aspect, the amount of the acrylate polymer may be not greater than 40 wt %, or not greater than 30 wt %, or not greater than 20 wt %, or not greater than 15 wt %, or not greater than 10 wt %.

In another embodiment, the amount of the reactive polysilsesquioxane may be at least 0.01 wt % based on the total weight of the curable composition, or at least 0.05 wt %, or at least 0.08 wt %, or at least 0.1 wt %, or at least 0.2 wt %, or at least 0.5 wt %, or at least 1.0 wt %, or at least 2.0 wt %, or at least 5 wt %, or at least 10 wt %. In yet a further aspect, the amount of the PSS may be not greater than 20 wt %, or not greater than 15 wt %, or not greater than 10 wt %, or not greater than 5 wt %, or not greater than 1 wt %, or not greater than 0.5 wt % based on the total weight of the curable composition.

The amount of the solvent in the curable composition can be at least 40 wt % based on the total weight of the curable composition, or at least 50 wt %, or at least 60 wt %, or at least 70 wt % or at least 80 wt %, or at least 85 wt %, or at least 90 wt %, or at least 92 wt %, or at least 95 wt %. In one aspect, the amount of the solvent may be not greater than 99 wt %, or not greater than 97 wt %, or not greater than 95 wt %, or not greater than 93 wt %, or not greater than 90 wt %, or not greater than 85 wt %, or not greater than 80 wt %, or not greater than 70 wt % based on the total weight of the curable composition.

The solvent of the curable composition is not limited, as long it can dissolve the first polymer and the second polymer of the curable composition. Non-limiting examples of suitable solvents of the curable composition can be ethyl acetoacetate (EAA), ethyl lactate (EL), cyclohexanone, propylene glycol methyl ether acetate (PGMEA), or γ-butyrolactone (GBL). In a particular aspect, the solvent can include ethyl acetoacetate.

The curable composition can further include a cross-linking catalyst (also called herein inter-changeable polymerization catalyst or polymerization initiator). In aspects, the cross-linking catalyst can be a thermal acid generator, or a thermal base generator, or a photoacid generator, or a photo-base generators.

In a particular aspect, the cross-linking catalyst can be a thermal acid generator. Non-limiting examples of a thermal acid generator can be a triarylsulfonium salt, or a dialkylphenylsulfonium salt, or a diazeniumdiolate, or a sulfonate ester, or a ketoxime ester, or an imide, or a N-sulfonyloxaziridine, or a benzoin ether, or a sulfonylhydrazide.

In one embodiment, the curable composition of the present disclosure can be essentially free of particles, for example being essentially free of pigment particles. As used herein, being essentially free of particles means that the curable composition contains not more than 50 particles per ml having a size of 200 nm or greater, or not more than 50 particles per ml having a size of 150 nm or greater, or not more than 50 particles per ml having a size of 100 nm or greater, or not more than 50 particles per ml having a size of 50 nm or greater, or not more than 50 particles per ml having a size of 30 nm or greater.

In another embodiment, the viscosity at 23° C. of the curable composition can be not greater than 50 mPa·s, or not greater than 40 mPa·s, or not greater than 35 mPa·s, or not greater than 30 mPa·s, or not greater than 25 mPa·s, or not greater than 20 mPa·s. In another aspect, the coating composition can have a viscosity of at least 5 mPa·s, or at least 10 mPa·s, or at least 15 mPa·s, or at least 20 mPa·s. As used herein, the viscosities relate to Brookfield viscosities, measured with a Brookfield viscometer at 23° C.

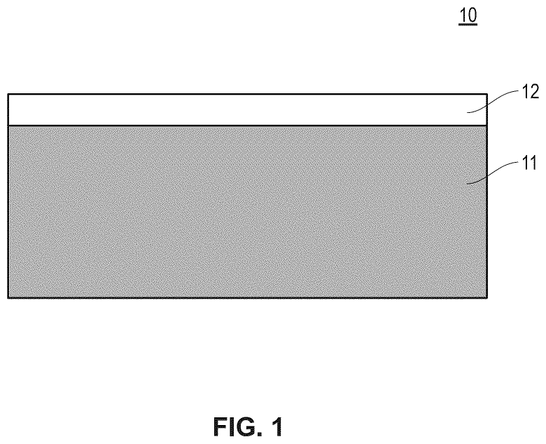

FIG. 1 includes an illustration of a side view of a coated superstrate (10), containing a superstrate blank (11) and a solid polymeric layer (12) directly overlying the superstrate blank (11).

In one embodiment, the solid polymeric layer (12) can be a cured coating of the above-described curable composition.

In one embodiment, the solid polymeric layer (12) can be formed by applying a liquid layer of the above-described curable composition of the present disclosure via spin-coating on a first outer surface of a superstrate blank (11). The liquid layer can be cured by heating the coated superstrate in the presence of a cross-linking catalyst. In a certain aspect, the cross-linking catalyst can be a thermal acid generator.

In one aspect, the curing temperature can be at least 80° C., or at least 100° C., or at least 130° C., or at least 150° C., or at least 180° C. In another aspect, the curing temperature may be not greater than 300° C., or not greater than 250° C., or not greater than 220° C.

The amount of the cross-linking catalyst in the curable composition can be at least 0.00001 wt % based on the total weight of the curable composition, or at least 0.0001 wt %, or at least 0.001 wt %, or at least 0.01 wt %, or at least 0.1 wt %. In one aspect, the amount of the thermal acid generator may be not greater than 0.5 wt % based on the total weight of the curable composition, or not greater than 0.1 wt %, or not greater than 0.05 wt %.

In one embodiment, before coating the superstrate blank with the curable composition of the present disclosure, the curable composition can be filtered through a filter having a pore size of not greater than 0.1 microns, or not greater than 0.05 microns, or not greater than 0.02 microns, or not greater than 0.01 microns in order to remove particles.

In a certain aspect, an average thickness of the solid polymeric layer (12) can be at least 0.005 microns, or at least 0.010 microns, or at least 0.020 microns, or at least 0.050 microns, or at least 0.1 microns, or at least 0.2 microns, or at least 0.3 microns, or at least 0.5 microns, or at least 1 micron. In another aspect, the average thickness of the solid polymeric layer may be not greater than 10 microns, or not greater than 5 microns, or not greater than 2 microns, or not greater than 1 micron, or not greater than 0.5 microns.

Based on the fluorine content of the reactive polysilsesquioxane and the amount of reactive polysilsesquioxane in the curable composition, the fluorine content of the formed polymeric solid layer after curing can be or at least 0.001 wt %, or at least 0.01 wt %, or at least 0.1 wt %, or at least 1 wt %. In another aspect, the fluorine content of the formed polymeric solid layer may be not greater than 5 wt % based on the total weight of the curable composition, or not greater than 1 wt %, or not greater than 0.1 wt %, or not greater than 0.01 wt %.

In a further embodiment, the superstrate blank can be made from a variety of materials. Non-limiting examples of materials can include a glass-based material, silicon, a spinel, a fused-silica, quartz, an organic polymer, a fluorocarbon polymer, or any combination thereof. The glass-based material can include soda lime glass, borosilicate glass, alkali-barium silicate glass, quartz glass, aluminosilicate glass, or synthetic fused-silica.

In a particular aspect, the coated superstrate can be transparent to a selected actinic radiation used for curing a formable material, for example, to cure a resist during planarization at a certain UV light wave range.

In a certain embodiment, the coating (12) can be a single-layer coating. In another certain embodiment, the coating can be a multi-layer coating.

It has been surprisingly found that curable compositions containing only a minor amount of reactive polysilsesquioxane can lead to cured polymeric layers (12) having an excellent hydrophobicity. In one embodiment, the water contact angle of the solid polymeric layer (12) can be at least 75°, or at least 80°, or at least 85°, or at least 90°. In a further aspect, the water contact angle may be not greater than 140°, or not greater than 120°, or not greater than 100°, or not greater than 96°, or not greater than 90°.

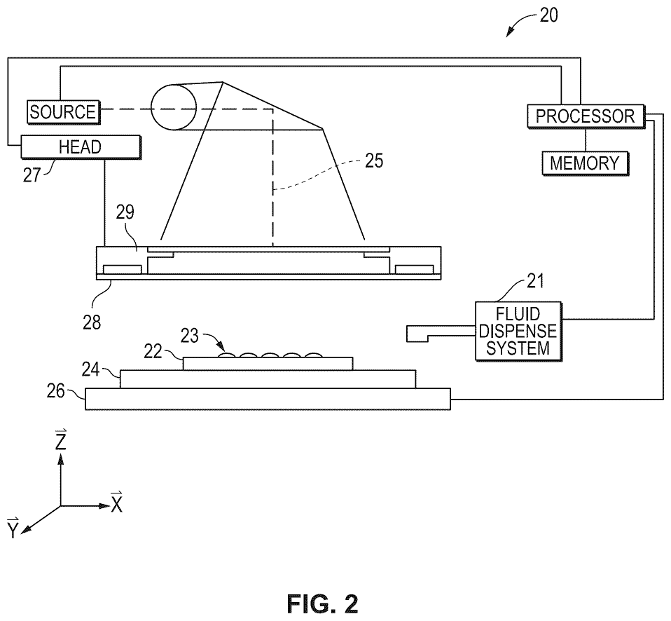

Referring to FIG. 2, a system (20) in accordance with an embodiment described herein can be used to planarize a formable material (23) on a substrate (22) using the coated superstrate (28) of the present disclosure. The coated superstrate (28) can be positioned spaced-apart from the substrate (22).

The substrate (22) may be coupled to a substrate holder (24), for example, to a chuck. The chuck may be any chuck including vacuum, pin-type, groove-type, electrostatic, electromagnetic, or the like. The substrate (22) and substrate holder (24) may be further supported by a stage (26). The stage (26) may provide translating or rotational motion along the X-, Y-, or Z-directions.

The coated superstrate (28) can be used to planarize a formable material deposited on a substrate (22). The coated superstrate (28) can be coupled to a superstrate holder (29). The coated superstrate (28) may be both held by and its shape modulated by the superstrate holder (29). The superstrate holder (29) may be configured to hold the superstrate (28) within a chucking region. The superstrate holder (29) can be configured as vacuum, pin-type, groove-type, electrostatic, electromagnetic, or another similar holder type. In one embodiment, the superstrate holder (29) can include a transparent window within the body of the superstrate holder (29).

The system (20) can further include a fluid dispense system (21) for depositing a formable material (23) on the surface of the substrate (22). The formable material (23) can be positioned on the substrate (22) in one or more layers using techniques such as droplet dispense, spin-coating, dip coating, chemical vapor deposition (CVD), physical vapor deposition (PVD), thin film deposition, thick film deposition, or combinations thereof. The formable material (23) can be dispensed upon the substrate (22) before or after a desired volume is defined between the superstrate (28) and the substrate (22). The formable material (23) can include one or more polymerizable monomers and/or oligomers and/or polymers that can be cured using actinic radiation and/or heat.

As further demonstrated in the examples, it has been discovered that a cost-efficient coated superstrate can be made with a high hydrophobicity and being suitable for IAP processing by applying the curable composition of the present disclosure on a superstrate and curing the composition. It was surprising that a low release force may be needed for separating the coated superstrate after curing a resist.

### EXAMPLES

The following non-limiting examples illustrate the concepts as described herein.

### Example 1

A first series of curable compositions was prepared by combining different ratios of a poly (methyl methacrylate) copolymer (X-PMMA-1) and a fluorine-containing polysilsesquioxane copolymer (PSS-F) in a solvent. Each curable composition further contained about 0.04 wt % of the thermal acid generator TAG2678 from King Industries Inc. as polymerization catalyst.

The X-PMMA-1 copolymer (which falls under the first polymer of the present disclosure) was made by combining 92.5 mol % methyl methacrylate (MMA) and 7.5 mol % glycidyl methacrylate (GMA). The X-PMMA-1 was dissolved in ethyl acetoacetate to form a 20 wt % polymer solution for further use.

The fluorine-containing polysilsesquioxane copolymer PSS-F (which falls under the second polymer of the present disclosure) was made by hydrolysis and condensation of 5 mol % 1H, 1H,2H,2H-nonafluorohexyl-trimethoxysilane (NFHTMS), 45 mol % methyltrimethoxysilane (MTMS), and 50 mol % tetraethoxysilane (TEOS). The PSS-F was dissolved in PGMEA to form a 10 wt % polymer solution for further use.

The curable compositions were prepared by combining the X-PMMA-1 and PSS-F polymer solutions to reach desired ratios of X-PMMA-1 and PSS-F (see Table 1) and adding the thermal acid generator. Thereafter, the curable compositions were stirred at room temperature (23° C.) overnight followed by filtering through an 0.1 micron pore size PTFE filter. The viscosities of the curable compositions after filtering were between 4 mPa·s and 10 mPa·s measured with the Brookfield method at 23° C.

Coating layers were prepared by applying 8 ml of the curable compositions on a silicon wafer having a diameter of 200 mm via spin-coating using a Cee® Spin Coater at a rotation speed of 1000 rpm for 60 seconds. Thereafter, the applied coating was cured at 205° C. for 180 seconds. The thickness of the obtained coating layers was between 0.25 and 0.5 microns.

A summary of the coating compositions and the measured water contact angles to the cured layers is shown in Table 1.

TABLE 1

| | Polymer 1 | Polymer 2 | Wt % Ratio | Water | IAP-R |
|---|---|---|---|---|---|
| | X-PMMA-1 | PSS-F | Polymer 1/ | contact | contact |
| Sample | [wt %] | [wt %] | Polymer 2 | angle [°] | angle [°] |
| S1 | 8 | 0.1 | 80 | 67.7 | 30.1 |
| S2 | 8 | 0.5 | 16 | 87.7 | 51.7 |
| S3 | 8 | 0.75 | 10.7 | 89.8 | 57.2 |
| S4 | 8 | 1.0 | 8 | 92.9 | 61.4 |
| C1 | 8 | 0 | — | 68.7 | 10.2 |
| C2 | 0 | 1.0 | — | 95.7 | 58.1 |

It can be seen that already a minor amount of 0.5 wt % of the polysilsesquioxane in the curable composition in combination with 8 wt % of X-PMMA-1 was sufficient to form cured layers having a water contact angle of 87.7 degrees, which is close the water contact angle to a layer formed with comparative composition C2, wherein only the PSS-F was used as polymer-ingredient and a water contact angle of 95.7 degrees was obtained.

In contrast, if the curable composition only contained X-PMMA-1 (comparative sample C1), the water contact angle was much lower (68.7 degrees).

The contact angle was also measured using instead of water a liquid resist typically used in IAP processing, called herein IAP-R. The IAP-R contained about 95 wt % of multi-functional styrene monomers, a photoinitiator and a surfactant. The test results of the IAP-R contact angles show that a similar trend was observed as with water, i.e., that at an amount of 0.5 wt % PSS-F in the curable composition and higher the resist contact angle to the surface of a cured layer formed from the curable composition was close to the contact angle of a cured layer containing only cross-linked PSS-F polymer (comparative sample C2).

### Example 2

A second series of curable compositions was prepared by combining different ratios of a poly (methyl methacrylate) copolymer (X-PMMA-2) and a fluorine-free polysilsesquioxane copolymer (PSS-H). Each curable composition contained about 0.1 wt % of the thermal acid generator TAG2678 as polymerization catalyst.

The X-PMMA-2 copolymer (which falls under the first polymer) was made by combining 77.5 mol % methyl methacrylate (MMA) and 22.5 mol % glycidyl methacrylate (GMA). The X-PMMA-2 was dissolved in ethyl acetoacetate to form a 20 wt % polymer solution for further use.

The fluorine-free polysilsesquioxane PSS-H (which falls under the second polymer) was made by hydrolysis and condensation of 17.5 mol % isobutyltrimethoxysilane (IBTMS), 6 mol % phenyltrimethoxysilane (PTMS), 44 mol % methyltrimethoxysilane (MTMS), and 32.5 mol % tetraethoxysilane (TEOS). The polysilsesquioxane was dissolved in PGMEA to form a 10 wt % polymer solution.

After combining all ingredients, the curable compositions were stirred at room temperature (23° C.) overnight and thereafter filtered through a 0.1 micron pore size PTFE filter. The viscosity of the compositions after filtering was between 3 mPa·s and 6 mPa·s measured at 23° C. with the Brookfield method.

Coating layers were prepared by applying 8 ml of the curable compositions on a silicon wafer having a diameter of 200 mm via spin-coating using a Cee® Spin Coater at a rotation speed of 1500 rpm for 60 seconds. Thereafter, the applied coating was cured at 205° C. for 180 seconds. The thickness of the obtained coating layers was between 0.1 and 0.3 microns.

A summary of the coating compositions and the measured water contact angle to the cured layers is shown in Table 2.

TABLE 2

| | Polymer 1 | Polymer 2 | Wt % Ratio | Water | IAP-R |
|---|---|---|---|---|---|
| | X-PMMA-2 | PSS-H | Polymer 1/ | contact | contact |
| Sample | [wt %] | [wt %] | Polymer 2 | angle [°] | angle [°] |
| S5 | 19.5 | 0.5 | 39.0 | 72.0 | 22.7 |
| S6 | 18.25 | 1.25 | 14.6 | 72.5 | 26.5 |
| S7 | 17.5 | 2.5 | 7.0 | 76.2 | 33.8 |
| S8 | 15.0 | 5.0 | 3.0 | 81.5 | 36.0 |
| C3 | 20 | 0 | — | 65.9 | 9.1 |
| C4 | 0 | 1.0 | — | 82.2 | 38.0 |

The data in Table 2 show that using the fluorine-free polysilsesquioxane PSS-H in combination with the poly(meth)acrylate copolymer X-PMMA-2 in a curable composition, the polymeric layers formed after curing can also have high water contact angles and IAP-R contact angles as shown in Example 1 for the fluorine-containing PSS. However, when using the polymer combination X-PMMA-2 and PSS-H, weight % ratio of XPMAA-2 to PSSH should be not greater than 7 (see samples S7 and S8) in order to reach a water contact angle of at least 75 degrees and being close to the contact angle of a cured layer formed by using only the PSS-H as starting polymer in the curable composition (comparative sample C4).

### Measuring the Contact Angles

The contact angles were measured with a Drop Master DM-701 contact angle meter made by Kyowa Interface Science Co. Ltd. (Japan).

For the testing, 2 ml of deionized water or liquid resist (IAP-R) was added to the syringe, of which 2 μl sample per test was added by the machine to the surface of the coated and cured wafer. Drop images were continuously captured by a CCD camera from the time the water or resist drop touched the layer surface. The contact angle was automatically calculated by the software based on the analysis of the images. The water contact angles and resist contact angles presented in Tables 1 and 2 are the contact angles at a time of 3 seconds after the water drop or resist drop was touching the surface of the wafer coating (also called herein coated superstrate).

### Measuring the Viscosity

The viscosities of the curable compositions were measured using a Brookfield Viscometer LVDV-II+Pro at 200 rpm, with a spindle size #18 and a spin speed of 135 rpm. For the viscosity testing, about 6-7 mL of sample liquid was added into the sample chamber, enough to cover the spindle head. The sample contained in the chamber was about 20 minutes equilibrated to reach the desired measuring temperature of 23° C. before the actual measurement was started. For all viscosity testing, at least three measurements were conducted and an average value was calculated.

### Example 3

The coated silicon wafers made from the curable compositions described in Examples 1 and 2 (which are called hereafter “coated superstrates”) were tested to evaluate the release force needed for separating the coated superstrates after photo-curing and planarizing a liquid resist. A low release force typically corresponds to a low separation energy, which is desired and can reduce imprint defects.

For the testing, a liquid IAP resist was dropped onto a glass slide and the coated superstrate was placed on top of the resist drops to spread the resist uniformly to a single layer. As liquid IAP resist was used the same IAP resist used in Examples 1 and 2 for measuring the resist contact angles (IAP-R).

While being in direct contact with the coated superstrate, the liquid IAP resist was photo-cured with UV light by applying a total radiation dosage of 5 J, using a Dymax system. The release force needed for separating the coated superstrate after the photo-curing from the resist was determined by conducting a 4-point bending test according to a modified ASTM6272, using an Instron 542 instrument. The actually measured release force was further converted to a percentage of the release force reduction, using as 100% reference the release force required for the respective coating made without including polysilsesquioxane PSS-F or PSS-H.

The results of the test data are summarized in Tables 3 and 4.

TABLE 3

| | | | Release force | Reduced release |
|---|---|---|---|---|
| Sample | PSS-F | X-PMMA-1 | [lb] | force to C1 [%] |
| C1 | 0 | 8 | 1.368 | — |
| C2 | 1 | 0 | 0.512 | 62.58 |
| S1 | 0.1 | 8 | 0.952 | 30.41 |
| S2 | 0.5 | 8 | 0.791 | 42.20 |
| S3 | 0.75 | 8 | 0.649 | 52.56 |
| S4 | 1.0 | 8 | 0.639 | 53.29 |

TABLE 4

| | | | Release force | Reduced release |
|---|---|---|---|---|
| Sample | PSS-H | X-PMMA-2 | [lb] | force to C3 [%] |
| C3 | 0 | 20 | 0.818 | — |
| C4 | 1 | 0 | 0.374 | 54.28 |
| S5 | 0.5 | 19.50 | 0.799 | 2.32 |
| S6 | 1.25 | 18.25 | 0.695 | 15.04 |
| S7 | 2.5 | 17.50 | 0.544 | 33.50 |
| S8 | 5.0 | 15.00 | 0.436 | 46.70 |

Table 3 shows release-force data measured for coated superstrates formed from curable compositions comprising fluorinated polysilsesquioxane PSS-F and poly(meth)acrylate copolymer X-PMMA-1, while Table 4 relates to coated superstrates wherein the coating was made using a fluorine-free polysilsesquioxane PSS-H and a poly(meth)acrylate copolymer X-PMMA-2.

It can be seen that both types of coated superstrates made with fluorinated polysilsesquioxane (PSS-F) or a non-fluorinated PSS-H in the curable coating composition, could reduce the release force needed for the separation from the cured resist in comparison to a coated superstrate wherein the curable composition did not include a polysilsesquioxane (see comparative samples C2 and C4.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any sub combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A curable composition comprising:
a first polymer, the first polymer including a reactive acrylate polymer, the reactive acrylate polymer being essentially free of fluorine;
a second polymer, the second polymer including a reactive polysilsesquioxane; and
a solvent,
wherein the reactive polysilsesquioxane comprises hydroxyl groups and structure-units of formula (1) 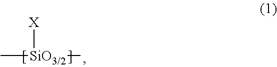
wherein X is alkyl, or aryl, or arylalkyl, or fluorine-containing alkyl, or any combination thereof;
a viscosity of the curable composition is not greater than 50 mPa·s;
a ratio of the first polymer to the second polymer is at least 2:1 and not greater than 20:1; and
a cured layer of the curable composition has a water contact angle of least 75 degrees.

2. The curable composition of claim 1, wherein the reactive polysilsesquioxane is a polymerization product of at least one first Si-containing monomer having a structure of formula (2) and at least one second Si-containing monomer having a structure of formula (3): 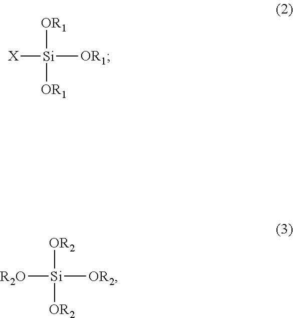
wherein R₁ and R₂ is C₁-C₆ alkyl, and X is alkyl, or aryl, or aryl-alkyl, or fluorine-containing alkyl.

3. The curable composition of claim 2, wherein the second Si-containing monomer is tetraethyl orthosilicate (TEOS).

4. The curable composition of claim 2, wherein an amount of the second Si-containing monomer is at least 20 wt % based on the total weight of monomers forming the polysilsesquioxane.

5. The curable composition of claim 1, wherein the polysilsesquioxane comprises fluorine.

6. The curable composition of claim 5, wherein X of formula (1) is —(CH₂)ₘ—CₙF₂ₙ₊₁, with n being 4-18, and m being 0-4.

7. The curable composition of claim 1, wherein the polysilsesquioxane is free of fluorine.

8. The curable composition of claim 7, wherein X of formula (1) is methyl, or ethyl, or phenyl, or isobutyl, or any combination thereof.

9. The curable composition of claim 1, wherein the acrylate polymer comprises structure units of formula (4) and formula (5): 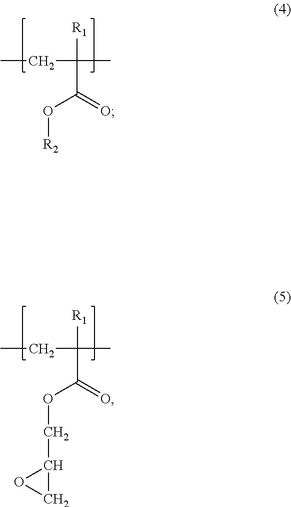
with R₁ being H or C₁-C₆ alkyl, R₂ being substituted or unsubsituted C1-C18 alkyl.

10. The curable composition of claim 9, wherein the acrylate polymer is a copolymer of methyl methacrylate (MMA) and glycidyl methacrylate (GMA).

11. The curable composition of claim 1, wherein a molecular weight of the acrylate polymer is at least 2,000 g/mol.

12. The curable composition of claim 1, wherein an amount of the solvent is at least 50 wt % based on the total weight of the curable composition.

13. The curable composition of claim 1, wherein the solvent includes ethyl acetoacetate (EAA), ethyl lactate (EL), cyclohexanone, propylene glycol methyl ether acetate (PGMEA), or γ-butyrolactone (GBL).

14. The curable composition of claim 1, further comprising a thermal acid generator as a crosslinking catalyst.

15. The curable composition of claim 1, wherein the curable composition is essentially free of particles.

16. The curable composition of claim 1, wherein an amount of the polysilsesquioxane is at least 0.01 wt % and not greater than 20 wt % based on the total weight of the curable composition.

17. A coated superstrate comprising:
a superstrate blank having a first surface and a second surface, the first surface and the second surface being opposite to each other;
a solid polymeric layer directly overlying the first surface of the superstrate blank, wherein
the solid polymeric layer is a cured coating of a curable composition, the curable composition comprising:
a first polymer, the first polymer including a reactive acrylate polymer, the reactive acrylate polymer being essentially free of fluorine;
a second polymer, the second polymer including a reactive polysilsesquioxane; and
a solvent,
wherein the reactive polysilsesquioxane comprises hydroxyl groups and structure-units of formula (1) 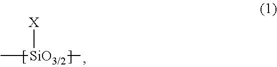
wherein X is alkyl, or fluorine-containing alkyl, or aryl, or alkyl-aryl; or fluorinated alkyl;
a viscosity of the curable composition is not greater than 50 mPa·s;
a ratio of the first polymer to the second polymer is at least 2:1 and not greater than 20:1; and
a water contact angle to the solid polymeric layer is at least 75 degrees.

18. The coated superstrate of claim 17, wherein a thickness of the solid polymeric layer is at least 5 nm and not greater than 10 microns.

19. A system for planarizing a formable material, comprising:
the coated superstrate of claim 17 coupled to a superstrate holder; and
a formable material positioned on a substrate,
wherein the coated superstrate is positioned above a top surface of the formable material and configured for planarizing the top surface of the formable material.

20. A method of forming a coated superstrate, comprising:
providing a superstrate blank having a first surface and a second surface, the first surface being opposite to the second surface;
applying by spin-coating on the first surface of the superstrate blank a liquid layer of the curable composition of claim 1; and
curing the curable composition to form the solid polymeric layer.
